(19) United States
(12) Patent Application Publication
(10) Pub. No.: US 2009/0287558 A1
(43) Pub. Date: Nov. 19, 2009

(54) Electronic Coupon Tracking

(75) Inventors: Deepak Seth, Clyde Hill, WA (US); Mrigankka Fotedar, Redmond, WA (US); Radhakrishnan Kadathur Srinivasan, Kirkland, WA (US); Urmila Singhal, Redmond, WA (US); Jaime Hwacinski, Sammamish, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/122,011

(22) Filed: May 16, 2008

(51) Int. Cl. G06Q 30/00

(52) U.S. Cl. 705/14.22

(57) ABSTRACT

In accordance with one or more aspects of the electronic coupon tracking, a record of an electronic coupon that has been distributed to a user is maintained. An indication that the electronic coupon has been redeemed at a retailer via a mobile device is received, and redemption of the electronic is recorded. Additionally, an indication can be received that the electronic coupon has been redeemed by the user. In response to receipt of this indication, a rewards account corresponding to the user is credited with one or more points.

### BACKGROUND

Retailers have traditionally accepted paper coupons, allowing consumers to receive goods and services at reduced costs. With computers becoming increasingly commonplace, distribution of some of these traditional paper coupons has migrated to the electronic realm, where the consumer can receive an email with a coupon that he or she can print out, or can access a World Wide Web (also referred to as simply the Web) page displaying a coupon that he or she can print out. However, various problems remain with such coupons. One such problem is that the user is still required to print out the coupon and take the printed coupon to the retailer for redemption. Another such problem is that it remains difficult for the creator and/or distributor of the coupon to know whether the user actually redeems the coupon.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

In accordance with one or more aspects of the electronic coupon tracking, a record of an electronic coupon that has been distributed to a user is maintained. An indication that the electronic coupon has been redeemed at a retailer via a mobile device is received, and redemption of the electronic coupon is recorded.

In accordance with one or more aspects of the electronic coupon tracking, an indication is received that an electronic coupon has been redeemed by a user. In response to receipt of the indication, a rewards account corresponding to the user is credited with one or more points.

### BRIEF DESCRIPTION OF THE DRAWINGS

The same numbers are used throughout the drawings to reference like features.

FIG. 1 illustrates an example system implementing the electronic coupon tracking in accordance with one or more embodiments.

FIG. 2 illustrates an example system illustrating downloading of electronic coupons to a mobile device in accordance with one or more embodiments.

FIG. 3 illustrates an example electronic coupon in accordance with one or more embodiments.

FIG. 4 is a flowchart illustrating an example process for implementing electronic coupon tracking in accordance with one or more embodiments.

FIG. 5 is a flowchart illustrating another example process for implementing electronic coupon tracking in accordance with one or more embodiments.

FIG. 6 illustrates an example computing device that can be configured to implement the electronic coupon tracking in accordance with one or more embodiments.

### DETAILED DESCRIPTION

Electronic coupon tracking is discussed herein. Electronic coupons can be distributed to a user's mobile device in various manners, including downloading results from the user searching for electronic coupons on the Internet, receiving electronic coupons from friends, and receiving electronic coupons from retailers. A tracking service tracks when electronic coupons are distributed to the user's mobile device, and further tracks when those electronic coupons are redeemed. Additionally, redemption of electronic coupons can be tied to an incentive or rewards system, allowing the user to receive points for redeeming electronic coupons, or for forwarding electronic coupons to friends that redeem those electronic coupons.

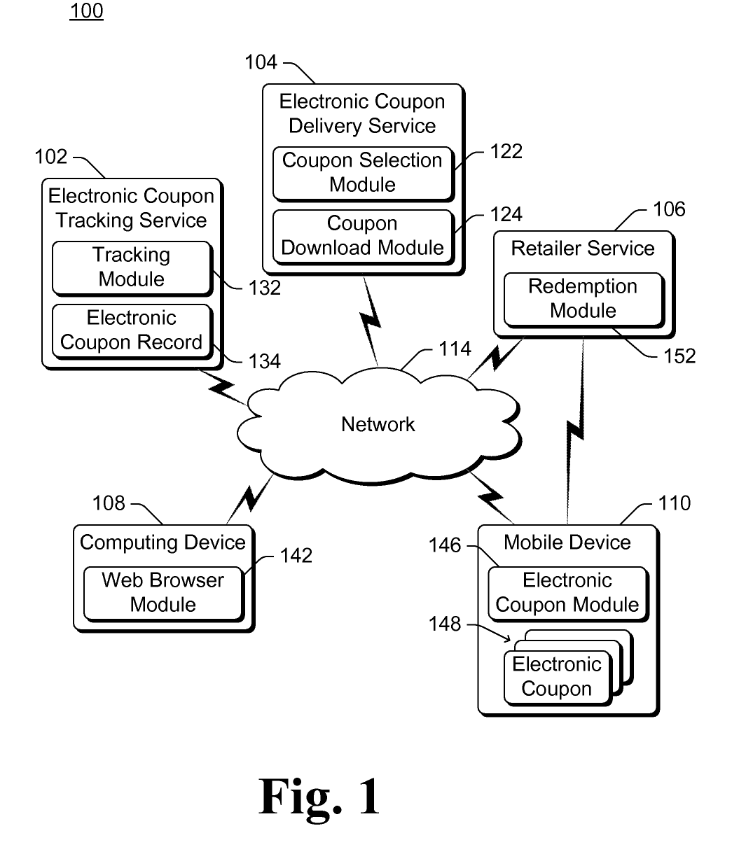

FIG. 1 illustrates an example system 100 implementing the electronic coupon tracking in accordance with one or more embodiments. System 100 includes an electronic coupon tracking service 102, an electronic coupon delivery service 104, a retailer service 106, a computing device 108, and a mobile device 110, which can communicate with one another via a network 114. Network 114 can be a variety of different networks, including the Internet, a local area network (LAN), a public telephone network, an intranet, other public and/or proprietary networks, combinations thereof, and so forth.

Electronic coupon delivery service 104 includes a coupon selection module 122 and a coupon download module 124. Coupon selection module 122 allows individual electronic coupons to be identified for downloading to mobile device 110 by download module 124. Coupon selection module 122 can identify electronic coupons in different manners, such as allowing users to search for coupons, allowing users to electronically send coupons to friends, automatically identifying coupons for a user, and so forth. The identification of particular electronic coupons to be downloaded to mobile device 110 is discussed in more detail below.

Electronic coupon tracking service 102 includes a tracking module 132 that tracks electronic coupons that are downloaded to mobile device 110 by electronic coupon delivery service 104. Tracking module 132 also receives notifications of when electronic coupons on mobile device 110 are redeemed. Tracking service 102 maintains an electronic coupon record 134 of the electronic coupons that are downloaded as well as the electronic coupons that are redeemed.

Computing device 108 can be a variety of different devices capable of accessing electronic coupon delivery service 104 via network 114. In one or more embodiments, electronic coupon delivery service 104 publishes one or more World Wide Web (also referred to as simply the Web) pages that can be retrieved by a web browser module 142 of computing device 108. Web browser module 142 can display these Web pages to a user of computing device 108, allowing the user to select particular electronic coupons and/or input criteria for identifying electronic coupons and/or sending coupons to friends as discussed in more detail below. Computing device 108 can be a variety of different devices, such as a desktop computer, a mobile station, an entertainment appliance, a set-top box communicatively coupled to a display device, a wireless phone, a game console, an automotive computer, and so forth.

Mobile device 110 can be a variety of different mobile devices. In one or more embodiments, mobile device 110 includes an electronic coupon module 146 that receives electronic coupons 148 from coupon download module 124 of electronic coupon delivery service 104. Module 146 can also receive electronic coupons from other sources, such as computing device 108, retailer service 106, another mobile device, and so forth as discussed in more detail below. Electronic coupon module 146 can also perform other coupon management tasks, such as sending electronic coupons to another mobile device, redeeming electronic coupons, maintaining a record of which electronic coupons are redeemed, and so forth as discussed in more detail below. Mobile device 110 can be a variety of different devices, such as a cell phone, personal digital assistant, smart card, key fob, and so forth.

Retailer service 106 includes a redemption module 152, and is typically implemented at a retailer where electronic coupons can be redeemed. Electronic coupon module 146 communicates with redemption module 152 to redeem electronic coupons 148, typically giving the user of mobile device 110 a discounted price for items such as particular products and/or services. In one or more embodiments, electronic coupon module 146 returns an indication to electronic coupon tracking service 102 of which electronic coupons 148 are redeemed. Alternatively, indications of which electronic coupons are redeemed can be returned to electronic coupon tracking service 102 in other manners, such as by redemption module 152.

Services 102, 104, and 106 are each implemented on one or more devices, such as one or more server computing devices. Services 102, 104, and 106 can be implemented on different devices, or alternatively two or more of services 102, 104, and 106 can be implemented on the same one or more devices.

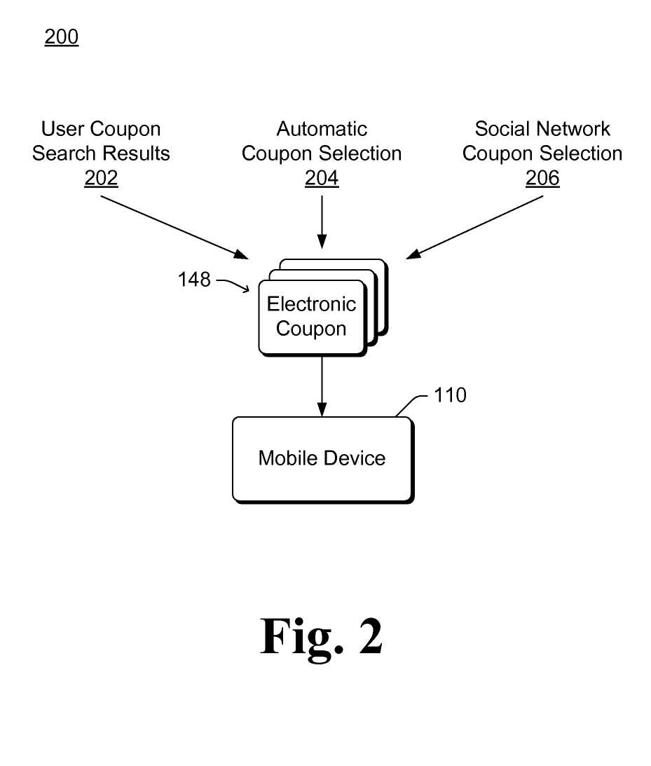

FIG. 2 illustrates an example system 200 illustrating downloading of electronic coupons to a mobile device in accordance with one or more embodiments. In system 200 one or more electronic coupons 148 are downloaded to mobile device 110. Electronic coupons 148 can be identified in different manners. In one or more embodiments, electronic coupons 148 are identified based on one or more of user coupon search results 202, automatic coupon selection 204, and social network coupon selection 206.

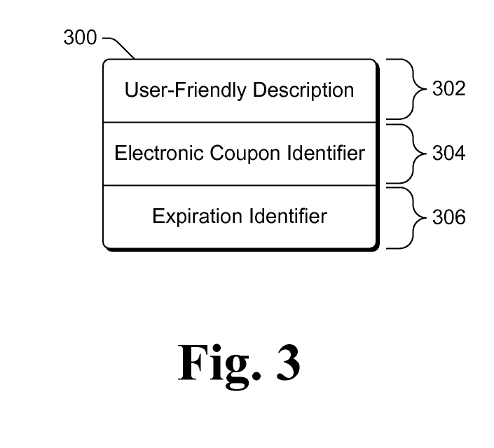

FIG. 3 illustrates an example electronic coupon in accordance with one or more embodiments. Electronic coupon 300 is, for example, an electronic coupon 148 of FIG. 1. Electronic coupon 300 includes a user-friendly description portion 302, an electronic coupon identifier portion 304, and optionally an expiration identifier portion 306. User-friendly description portion 302 is a description of electronic coupon 300 that can be displayed or otherwise presented to a user of a mobile device (such as a mobile device 110 of FIG. 1 or FIG. 2) and that is designed to typically be easily understood by the user of the mobile device. For example, this description may indicate that a particular product can be purchased two for the price of one, or that a particular service can be purchase with a $10 discount. This description can be text, an image or picture, video, audio, and/or combinations thereof.

Electronic coupon identifier portion 304 includes an identifier of electronic coupon 300. This identifier of electronic coupon 300 can be used when electronic coupon 300 is redeemed, and can allow the retailer at which electronic coupon 300 is being redeemed to identify what discount electronic coupon 300 allows the user to receive. The particular discount can be encoded in the identifier in portion 304, or alternatively the identifier in portion 304 can be used as an index into a table or record of discounts in order to identify the particular discount. Alternatively, electronic coupon 300 can include an identifier of the coupon 300 in portion 304, and have a separate portion that describes what discount electronic coupon 300 allows the user to receive. Additionally, this identifier of electronic coupon 300 can be used for tracking when electronic coupon 300 is downloaded to a mobile device. These uses of the identifier of electronic coupon 300 are discussed in more detail below.

Expiration identifier portion 306 includes an expiration time and/or date for electronic coupon 300. This expiration time and/or date can be an explicit value (e.g., Dec. 25, 2008) or an implicit value (e.g., two hours after the electronic coupon is downloaded to a mobile device). Alternatively, if electronic coupon 300 has no expiration time and/or date, then portion 306 need not be included in electronic coupon 300. Additionally, in one or more embodiments the expiration time and/or date is included as part of the electronic coupon identifier in portion 304, in which case electronic coupon 300 need not include portion 306.

Additionally, one or more other portions including metadata regarding electronic coupon 300 can be included in electronic coupon 300. For example, a portion of electronic coupon 300 can include a summary of electronic coupon 300 that can be displayed to a user (e.g., allowing the user to accept or decline a particular electronic coupon 300 from a friend, as discussed in more detail below). By way of another example, an age range tag or other tag describing an intended recipient of electronic coupon 300 can be included as a portion of electronic coupon. A device, such as the mobile device to receive electronic coupon 300, can compare such tags to characteristics of the user of the mobile device and download the electronic coupon 300 to the mobile device only if the tags are satisfied. For example, an electronic coupon 300 may include a tag indicating that the electronic coupon 300 is for adults (e.g., users that are at least 18 years old). If the user of the mobile device is not an adult, then the electronic coupon is not downloaded to the user's mobile device.

Returning to FIG. 2, user coupon search results 202 refer to electronic coupons that are identified by a user of mobile device 110 searching for the coupons. The user can search for coupons using mobile device 110 or alternatively another device, such as computing device 108 of FIG. 1. In one or more embodiments, a user can browse to or otherwise access one or more Web pages from which he or she can select electronic coupons for download. Such a Web page can display coupons based on a variety of different parameters, and the user can select from these displayed coupons. The Web page can automatically display particular coupons based on different criteria, such as frequently downloaded coupons, coupons for popular brand names, coupons for products or services that retailers and/or manufacturers desire to sell more of, and so forth.

In one or more embodiments the Web page allows the user to enter one or more keywords that can be used as search terms for identifying electronic coupons. For example, the user could enter names of products or services, descriptions of products or services, retailers where particular products or services can be purchased, and so forth. The Web page, or alternatively another component, can then search an electronic coupon database and identify one or more electronic coupons that match the keywords. An electronic coupon matches the keywords if at least one of the keywords is included in the electronic coupon or in metadata corresponding to the electronic coupon. In situations where greater than a threshold number of electronic coupons match the keywords, only the threshold number of electronic coupons are identified. The particular electronic coupons matching the keywords that are identified can be selected in a variety of different manners, such as selecting coupons matching more keywords before selecting coupons matching fewer keywords, selecting coupons based on whether the user has previously downloaded the same or similar coupons, selecting coupons based on a particular retailer where the coupon can be redeemed, selecting coupons randomly, and so forth.

Alternatively, rather than browsing to Web pages, one or more other applications can be used to identify electronic coupons for downloading. Such an application can be an application executing on a remote device, such as on a server of electronic coupon delivery service 104 of FIG. 1. Alternatively, such an application can be executing on a local device being used by the user, such as computing device 108 or mobile device 110 of FIG. 1. An application executing on a local device can be implemented in a variety of different manners, such as a stand-alone application that can access a coupon database, a web browser plug-in, a gadget (such as a Windows Vista® operating system gadget; additional information regarding such gadgets is available from Microsoft Corporation of Redmond, Wash.), and so forth.

Additionally, a user can enter one or more preferences that can be used with, or alternatively in place of, the keywords discussed above. Examples of such preferences include, categories of coupons that the user desires to receive (e.g., food coupons, automobile maintenance coupons, video game coupons, movie coupons, and so forth), brands that the user likes, retailers that the user likes, and so forth. These preferences can optionally be maintained by a Web page or other application searching a database for coupons so that the user need not reenter these preferences each time he or she searches for coupons. Similarly, keywords from previous searches can be maintained by the Web page or other application so that the user can easily perform the same search at different times.

In one or more embodiments, location information can also be used when searching for coupons. The location information can be manually entered by a user, such as the user entering his or her current ZIP code, a ZIP code where he or she plans to shop, an address where he or she is currently located or plans to shop, his or her phone number, and so forth. Alternatively, the location information can be identified automatically by the Web page or other application searching a database for coupons. The location information can be automatically identified in different manners, such as based on the phone number (e.g., the area code) of the users' device (e.g., mobile device 110), GPS (Global Positioning System) coordinates from a GPS component or module of or coupled to the user's device (e.g., mobile device 110), a cell site or transmitter that the user's device (e.g., mobile device 110) is communicating with, and so forth.

A variety of different conventional search algorithms or techniques can be employed to identify electronic coupons using these keywords, preferences, and/or location information criteria. The search algorithms can treat these criteria equally, or alternatively weight these criteria differently (e.g., weighting location information more heavily than preferences, weighting keywords more heavily than location information, and so forth).

In addition to the user searching for coupons based on keywords, preferences, and/or location information, in one or more embodiments electronic coupons can be automatically identified and sent to the user. Automatic coupon selection 204 is performed to automatically identify electronic coupons 148 to be downloaded to mobile device 110. This automatic selection can be performed in a variety of different manners. In one or more embodiments, the user enters one or more keywords, one or more preferences, and/or location information that is saved by a Web page or other application searching a database for coupons. The Web page or other application then automatically performs the search using this user-entered information. The search can be performed at different intervals, such as hourly, daily, weekly, whenever a new electronic coupon is added to the database, and so forth. The particular time interval can be identified by the Web page and/or other application, or alternatively can be identified by the user.

In one or more other embodiments, location information is automatically obtained and used to automatically identify electronic coupons 148. Location information can be automatically broadcast by mobile device 110, or alternatively the location information can be obtained from other components or modules (e.g., from a cell site or transmitter). For example, GPS coordinates identifying a current location of mobile device 110 or a cell site identifying a current location of mobile device 110 can be used to identify electronic coupons 148. This allows retailers to have electronic coupons distributed to mobile devices 110 that are in close geographic proximity to the retailers. For example, a restaurant in a shopping mall could have electronic coupons distributed to mobile devices 110 that are currently in, or close to, a shopping mall. This close geographic proximity can be a variety of different values, such as within 1000 feet, within 1 mile, and so forth.

In addition to search results 202 and automatic coupon selection 204, social network coupon selection 206 can also be performed to identify coupons 148 for downloading to mobile device 110. Social network coupon selection 206 refers to one or more friends or other members of a user's social network identifying electronic coupons 148 for the user of mobile device 110. A social network refers to a collection of friends, co-workers, acquaintances, and so forth. The members of a social network are generally referred to herein as friends, although it is to be appreciated that other relationships (e.g., co-workers, business partners, family, etc.) can be reflected in social networks. Examples of social networks can include online communities, email address books, cell phone address books, buddy lists from Web sites or video games, and so forth. In one or more embodiments the social network can be part of a Windows Live™ network of Internet services where a user of mobile device 110 is assigned an identifier and can select identifiers of other users of the Windows Live™ network of Internet services to be part of his or her social network.

A friend in the user's social network can identify one or more electronic coupons 148 to be downloaded to the user's mobile device 110 in a variety of different manners. In one or more embodiments, the friend can identify electronic coupons based on keywords, preferences, and/or location information as discussed above. Additionally, the Web page or other application presents a user interface to the friend allowing the friend to select particular electronic coupons and select which members of the friend's social network are to receive the particular electronic coupons. As the user of mobile device 110 is part of the friend's social network, the friend can select any electronic coupons that he or she desires to be downloaded to the user's mobile device 110. Thus, a user's friends are able to keep an eye out for electronic coupons that they believe may be of interest to the user, and can have such electronic coupons downloaded to the user's mobile device 110.

In other embodiments, the friend can forward to the user's mobile device an electronic coupon that he or she receives (e.g., has been downloaded to the friend's mobile device). This forwarding of the electronic coupon can also be referred to as downloading of the electronic coupon to mobile device 110. Thus, rather than accessing a Web page or other application that searches a coupon database, the friend can simply forward electronic coupons that he or she receives to mobile device 110.

Regardless of the manner in which a friend in the user's social network identifies one or more electronic coupons 148 to be downloaded to the user's mobile device 110, in one or more embodiments a notification of the one or more electronic coupons 148 identified by the friend are forwarded to mobile device 110. This notification can include a variety of different information, such as an identifier of the friend, a description or summary of the one or more electronic coupons 148 (such a summary can optionally be included as a portion of electronic coupon 300 of FIG. 3), and so forth. Based on the notification, the user is prompted via mobile device 110 to accept or decline the one or more electronic coupons 148. If the user accepts the electronic coupons, then the one or more electronic coupons 148 identified by the friend are downloaded to mobile device 110. If the user declines the electronic coupons, the one or more electronic coupons 148 identified by the friend are not downloaded to mobile device 110. The one or more electronic coupons 148 identified by the friend can be accepted or declined as a group, or alternatively individual ones of the one or more electronic coupons 148 can be accepted and declined. In alternate embodiments, the one or more electronic coupons 148 identified by the friend are downloaded to the user's mobile device 110 without any prompting for the user of mobile device 110 to accept or decline the electronic coupons.

Leveraging social networks to distribute electronic coupons allows for various different usage scenarios. For example, users can easily identify electronic coupons that they believe will be of interest to their friends and easily have those electronic coupons downloaded to their friends' mobile devices (optionally with their friends being notified of those electronic coupons and being prompted to accept or decline the electronic coupons). Additionally, users can set up a profile that identifies their interests to notify their friends of what types of electronic coupons they would like their friends to look for on their behalf. Furthermore, a user of a social network can identify one or more groups of friends (or other members of the social network) the particular electronic coupons are to be sent to. For example, a user can identify a first group of friends that he or she typically sends automotive maintenance coupons to, a second group of friends that he or she typically sends food coupons to, a third group of friends that he or she typically sends a electronics coupons to, and so forth.

Additionally, in one or more embodiments multiple users in a social network can be linked together. When an electronic coupon is downloaded to a mobile device of one of these users, the electronic coupon is also downloaded to any other users' mobile devices to which that one user is linked. For example, a husband and wife can be linked together, so when the wife has an electronic coupon for a particular item downloaded to her mobile device, that same electronic coupon is also downloaded to her husband's mobile device.

As discussed above, one or more of electronic coupons 148 can have an expiration time and/or date. In one or more embodiments, electronic coupons 148 that are past their expiration time and/or date are not downloaded to mobile device 110. Accordingly, mobile device 110 typically receives electronic coupons 148 that are still valid and have not expired. Alternatively, electronic coupons 148 can be downloaded to mobile device 110 without regard for whether they have expired. In such situations, a check whether the electronic coupon is still valid can be performed when a user of mobile device 110 attempts to redeem the electronic coupon. This redemption process is discussed in more detail below.

Electronic coupons 148 can be downloaded to mobile device 110 in a variety of different manners. This downloading can be in accordance with public and/or proprietary protocols for transferring data. In one or more embodiments, electronic coupons 148 are downloaded to mobile device 110 using HTTP (HyperText Transfer Protocol) communications protocol. In other embodiments, mobile messaging protocols are used to download electronic coupons to mobile device 110, such as the SMS (Short Message Service) communications protocol, the Multimedia Messaging Service (MMS) communications protocol, Enhanced Messaging Service (EMS) communications protocol, and so forth. In other embodiments, email protocols are used to download electronic coupons to mobile device 110, such as the POP (Post Office Protocol) versions, IMAP (Internet Message Access Protocol), SMTP (Simple Mail Transfer Protocol), and so forth. It is to be appreciated that these protocols are only examples, and that one or more other protocols can alternatively be used.

Electronic coupons can be authored and added to a coupon database for searches and/or or communicated automatically to mobile device 110 as discussed above. In one or more embodiments, a coupon authoring component or module is used to assist in authoring electronic coupons. This coupon authoring component or module can reside on a user's device (e.g., computing device 108 or mobile device 110 of FIG. 1), can reside on a server device that is accessed by the user's device, or on another device. In one or more embodiments, the coupon authoring component or module is part of electronic coupon module 146 of FIG. 1.

The coupon authoring component or module allows an electronic coupon, such as electronic coupon 300 of FIG. 3, to be created. The coupon authoring component or module assigns a coupon identifier to the electronic coupon being authored. The coupon authoring component or module can generate the coupon identifier itself, or alternatively access another component or service (such as electronic coupon tracking service 102 of FIG. 1) to obtain the coupon identifier. The coupon authoring component or module allows the user to input or select a user-friendly description of the electronic coupon, the particular discount that the electronic coupon provides, and optionally an expiration time and/or date for the electronic coupon. The coupon authoring component or module can optionally assist the user in identifying text, images, video, audio, and/or other types of content to be included in the electronic coupon, as well as any other desired tags or metadata to be included in the electronic coupon.

The electronic coupon authoring component or module allows for various usage scenarios. For example, a retailer using a computing device can generate multiple electronic coupons to be added to a coupon database and made available for downloading to mobile devices. By way of another example, a retailer using his or her mobile device can generate an electronic coupon to be automatically downloaded to other mobile devices within close geographic proximity to the retailer's mobile device. As a specific example, a retailer could generate an electronic coupon two hours before his or her business closes for the day, the electronic coupon offering a reduced price for the rest of the day on products the retailer desires to sell that day. The electronic coupon authoring component or module uploads this electronic coupon to electronic coupon delivery service 104 of FIG. 1, and automatic coupon selection 204 of FIG. 2 is performed to identify this electronic coupon to other mobile devices within close geographic proximity to the retailer's mobile device.

Returning to FIG. 1, electronic coupon tracking service 102 includes a tracking module 132 that tracks the downloading and redemption of electronic coupons. In one or more embodiments, a user identifier is tracked when an electronic coupon is downloaded. The user identifier can be identified in a variety of different manners, such as the user logging into a particular social network with the user identifier prior to searching for coupons, the user providing his or her user identifier prior to downloading coupons from a Web page, and so forth. This user identifier can also be identified in other manners, such as selection of a particular user identifier to receive an automatically selected coupon, selection of a particular user identifier by a friend in the user's social network, and so forth.

A notification including this user identifier as well as an identifier of the electronic coupon that is downloaded is sent to tracking module 132. This notification includes the user identifier of the user to whose mobile device the electronic coupon is downloaded, and in situations where a friend in the user's social network identifies the electronic coupon the notification also includes the user identifier of this friend. Tracking module 132 stores this received information in electronic coupon record 134, allowing tracking module 132 to know which electronic coupons have been downloaded by which users.

Alternatively, the user identifier can be embedded in an identifier of the electronic coupon. For example, referring to FIG. 3, an electronic coupon identifier having the user identifier embedded therein can be included in portion 304. Returning to FIG. 1, in such situations tracking module 132 need only track the electronic coupon identifier as it includes the user identifier.

In one or more embodiments, whenever an electronic coupon is downloaded to mobile device 110, the module responsible for sending the electronic coupon to mobile device 110 sends a notification to tracking module 132. This notification includes the user identifier as well as the electronic coupon identifier. For example, coupon download module 124 could send this notification, or an electronic coupon module of a mobile device sending an electronic coupon to mobile device 110 could send this notification. In other embodiments, the mobile device receiving the electronic coupon sends this notification to tracking module 132. For example, electronic coupon module 146 can send this notification to tracking module 132 upon receipt of an electronic coupon at mobile device 110.

Additionally, in one or more embodiments the user identifier is associated with an identifier of mobile device 110. This allows electronic coupons to be associated with particular devices and/or hardware. A mapping or other record of electronic coupons 148 to mobile device 110 can be maintained. In some situations, such as multiple users in a social network being linked together as discussed above (e.g., a husband and wife), an electronic coupon 148 can be mapped to or associated with multiple mobile devices 110 (e.g., the husband's mobile device and the wife's mobile device). This mapping or record can be obtained by electronic coupon module 146, in the electronic coupons 148 themselves, or alternatively elsewhere. This mapping or record allows the electronic coupon module to know when electronic coupons associated with a particular user identifier are downloaded (or redeemed, as discussed in more detail below), even if the user identifier is not known by the device receiving the downloaded electronic coupons.

For example, mobile device 110 could be a key fob, smart card, or other device that allows for storage and redemption of electronic coupons 148, but does not necessarily know the user's user identifier. However, device 110 has a device identifier that identifies device 110, and corresponds to the user identifier. This correspondence between device identifier and user identifier can be maintained in different locations, such as on a computing device 108 of the user, by electronic coupon delivery service 104, by another mobile device that mobile device 110 communicates with, and so forth. Thus, even though mobile device 110 may not know the user identifier, the user identifier can still be obtained and the notification of the user identifier as well as the electronic coupon identifier sent to tracking service 102.

As discussed above, electronic coupons can be identified for downloading to mobile device 110 in different manners. In one or more embodiments, restrictions can be imposed to limit how many times an electronic coupon can be downloaded. Such restrictions can be imposed in a variety of different manners. For example, coupon download module 124 can keep track of how many times the electronic coupon is downloaded and no longer identify the electronic coupon as being available for download after the electronic coupon has been downloaded a threshold number of times. This threshold number can be a default number used by module 124, can be included in metadata of the electronic coupon, or alternatively can be obtained elsewhere.

By way of another example, the electronic coupon can include a download count that is incremented each time the electronic coupon is downloaded. Once this download count reaches a threshold value, the electronic coupon is no longer identified as being available for download. By way of yet another example, tracking module 132 can maintain a count of how many times the electronic coupon has been downloaded and send a notification to electronic coupon delivery service 104 to no longer identify the electronic coupon as being available for download (and/or to delete the electronic coupon from a coupon database) after tracking module 132 determines that electronic coupon has already been downloaded a threshold number of times. As above, this threshold number can be a default number used by module 124, can be included in metadata of the electronic coupon, or alternatively can be obtained elsewhere.

Electronic coupon module 146 can communicate with redemption module 152 to allow a user of mobile device 110 to redeem one or more electronic coupons 148 via mobile device 110. The communication between mobile device 110 and redemption module 152 can be performed in a variety of different manners, including wired and/or wireless communication. For example, the communication can be performed using Bluetooth technology, USB (Universal Serial Bus) technology, Wireless USB technology, and so forth. The communication can be performed using RF (Radio Frequency) frequencies, visible optical frequencies, infrared optical frequencies, and so forth. In one or more embodiments, a light emitting diode (LED) on mobile device 110 emits a light sequence that can be received by a scanner device coupled to redemption module 152, analogous to the scanning of a barcode. An example of such a LED technique is the MoBeam™ technology, available from Ecrio Inc. of Cupertino, Calif.

In order to redeem an electronic coupon 148, an indication of the particular electronic coupon 148 is communicated to redemption module 152. This indication can take a variety of different forms. In one or more embodiments, a description of the discount that electronic coupon 148 allows is communicated to redemption module 152. For example, an indication that a particular product can be purchased two for the price of one can be communicated to redemption module 152. In other embodiments, an electronic coupon identifier for electronic coupon 148 is communicated to redemption module 152, which in turn accesses a record or database of electronic coupons to identify the discount that the electronic coupon having the received identifier allows. For example, a particular coupon identifier can be received and a database accessed to determine that the received coupon identifier corresponds to an electronic coupon allowing a particular product to be purchased two for the price of one.

In one or more embodiments, expiration information of the electronic coupon is checked as part of this redemption process. As discussed above, the electronic coupon can include an expiration date and/or time. This expiration information can be checked by electronic coupon module 146, with module 146 attempting to redeem the electronic coupon only if the coupon has not expired. Alternatively, the expiration information can be checked by redemption module 152, with module 152 redeeming the electric coupon only if the coupon has not expired.

In other embodiments, the expiration information is not included in the electronic coupon. In such embodiments, another service or device, such as electronic coupon tracking service 102, keeps track of whether the electronic coupon has expired. Electronic coupon module 146, or alternatively redemption module 152, sends a request to or otherwise accesses tracking service 102 to determine whether a particular electronic coupon 148 to be redeemed via mobile device 110 is valid or has expired. For example, tracking service 102 can track how many times a particular electronic coupon has been redeemed and return an indication that the electronic coupon is no longer valid after electronic coupon has been redeemed a threshold number of times.

Additionally, a notification of electronic coupons 148 that have been redeemed by mobile device 110 is returned to tracking module 132. In one or more embodiments this notification is returned by electronic coupon module 146, although this notification can alternatively be returned by other modules or components, such as redemption module 152. This notification indicates to tracking module 132 that a particular one or more electronic coupons have been redeemed by a particular user. A user identifier can be communicated along with identifiers of the redeemed electronic coupons or alternatively the user identifier can be embedded in the identifiers of the redeemed electronic coupons as discussed above.

Additionally, in one or more embodiments an identifier of a retailer at which an electronic coupon is redeemed is also included in the notification sent to tracking module 132. In embodiments where redemption module 152 returns the notification to tracking module 132, the retailer identifier can be included in the notification by redemption module 152. In embodiments where electronic coupon module 146 returns the notification to tracking module 132, redemption module 152 can communicate the retailer identifier to electronic coupon module 146 which in turn can include the retailer identifier in the notification being returned to tracking module 132.

Thus, tracking module 132 receives a notification when electronic coupons are downloaded to mobile device 110 and maintains a record of this downloading as part of record 134. Subsequently, when an electronic coupon is redeemed via mobile device 110, a notification of this redemption is returned to tracking module 132, which maintains a record of this redemption as part of record 134. Accordingly, tracking module 132 can readily determine whether a particular electronic coupon downloaded to a mobile device 110 has been redeemed.

Additionally, in one or more embodiments tracking module 132 implements, or alternatively works in conjunction with, a rewards system. This rewards system allows users to accumulate points in a rewards account when performing various tasks and request to redeem these points at a later time. The points can be redeemed in different manners, such as in exchange for products or services, in exchange for discounts for products or services, in exchange for cash rebates or credits, donation to charities, and so forth. When redeeming points, those points are deducted from the user's rewards account. The points can refer to dollar amounts, generic units, or any other measure desired by the rewards system.

The rewards system allows users to accumulate points for a variety of different tasks. In one or more embodiments, a user is credited with points in his or her rewards account whenever he or she redeems an electronic coupon 148. Thus, not only does the user receive the financial benefit of the coupon itself, but also receives points in his or her rewards account for redeeming the coupon.

Additionally, in one or more embodiments a user can accumulate points for performing different tasks. For example, a user can be credited with points each time an electronic coupon that he or she had downloaded or forwarded to a friend's mobile device is redeemed by that friend. This crediting of points can optionally be limited to a certain number of downloads. So if, for example, a first user forwards an electronic coupon to a second user, which forwards the electronic coupon to a third user, which forwards the electronic coupon to a fourth user, fewer than all of these users may be credited with points when the recipient redeems the electronic coupon. This limit can be a variety of different levels, such as allowing only two “forwards” so that if the fourth user were to redeem the electronic coupon, then the second user and the third user would be credited with points but the first user would not.

By way of another example, a user can be credited with points when he or she downloads an electronic coupon regardless of whether that coupon is redeemed. Furthermore, the points credited for performing different tasks can vary. For example, fewer points may be credited for downloading an electronic coupon than are credited for redeeming the electronic coupon.

The user's rewards account can be part of a retailer-specific loyalty program in which the user accumulates points for the particular retailer that can be redeemed only by that particular retailer. As discussed above, tracking module 132 can be provided with an identifier of a retailer at which an electronic coupon was redeemed, so tracking module 132 can know which retailer-specific rewards account is to be credited points when an electronic coupon is redeemed. Instead of the retailer-specific loyalty program, or in addition to the retailer-specific loyalty program, the rewards system can be part of a generic loyalty program in which the user accumulates points for performing tasks related to multiple retailers and that can be redeemed by multiple different retailers.

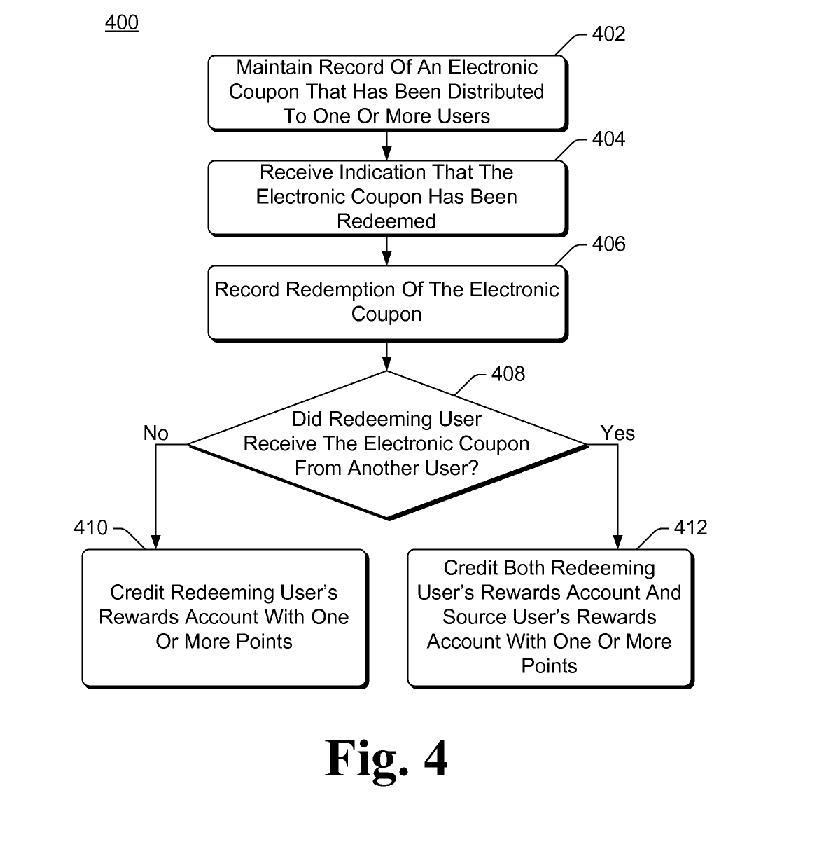

FIG. 4 is a flowchart illustrating an example process 400 for implementing electronic coupon tracking in accordance with one or more embodiments. Process 400 is carried out by one or more services or devices, such as tracking service 102 of FIG. 1, and can be implemented in software, firmware, hardware, or combinations thereof Process 400 is an example process for electronic coupon tracking; additional discussions of electronic coupon tracking are included herein with reference to different figures.

Initially, a record of an electronic coupon that has been distributed to one or more users is maintained (act 402). This electronic coupon can be authored in a variety of different manners as discussed above. Additionally, the electronic coupon can be distributed by downloading or forwarding the electronic coupon to a user's mobile device as discussed above. An electronic coupon tracking service, such as service 102 of FIG. 1, receives a notification of when the electronic coupon is downloaded to a mobile device and thus has been distributed to a user.

An indication that the electronic coupon has been redeemed is received (act 404), and the redemption of the electronic coupon is recorded (act 406). An electronic coupon tracking service, such as service 102 of FIG. 1, receives this indication and records the redemption.

A check is then made as to whether the user redeeming the electronic coupon received the electronic coupon from another user (act 408). As discussed above, electronic coupons can be obtained in different manners such as by the user searching for them, another user such as a friend forwarding the electronic coupon to the user, from a retailer, and so forth.

If the user redeeming the electronic coupon did not receive the electronic coupon from another user, then the user redeeming the electronic coupon has his or her rewards account credited with one or more points (act 410). The user can optionally be notified of this crediting of his or her rewards account.

However, if the user redeeming the electronic coupon did receive the electronic coupon from another user, then the user redeeming the electronic coupon has his or her rewards account credited with one or more points, and the other user (source user) that downloaded the electronic coupon to the user that redeemed the coupon also has one or more points credited to his or her rewards account (act 412). One or both of the user redeeming the electronic coupon and the other user that downloaded the electronic coupon to the user that redeemed the coupon can optionally be notified of this crediting to his or her rewards account.

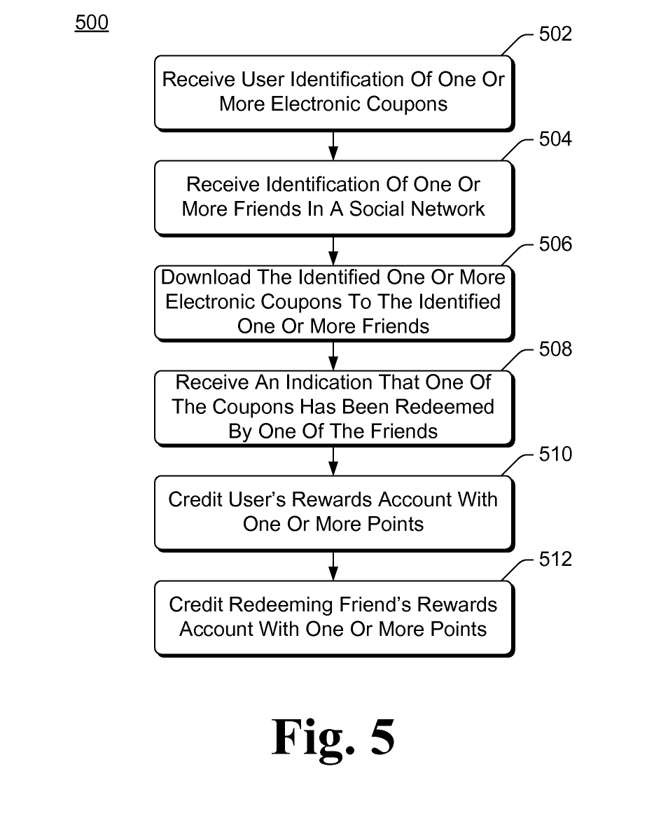

FIG. 5 is a flowchart illustrating an example process 500 for implementing electronic coupon tracking in accordance with one or more embodiments. Process 500 is carried out by one or more services or devices, and can be implemented in software, firmware, hardware, or combinations thereof. Process 500 is an example process for electronic coupon tracking; additional discussions of electronic coupon tracking are included herein with reference to different figures.

Initially, a user identification of one or more electronic coupons is received (act 502). In one or more embodiments multiple electronic coupons are displayed or otherwise presented to the user, and the user can identify particular ones of these multiple electronic coupons by selecting them on the display. Additionally, an identification of one or more friends in a social network is received (act 504). In one or more embodiments, a list of friends (or other members) of a social network to which the user belongs is displayed or otherwise presented to the user, and the user can identify particular ones of these friends by selecting them on the display.

The one or more electronic coupons identified in act 502 are then downloaded to the one or more friends identified in act 504 (act 506). When one of these electronic coupons has been redeemed, an indication that the electronic coupon has been redeemed by one of the friends is received (act 508). The rewards account of the user that performed the identifications in acts 502 and 504 is credited with one or more points in response to the coupon being redeemed (act 510). Additionally, the friend that redeemed the electronic coupon also has his or her rewards account credited with one or more points (act 512). The number of points credited in acts 510 and 512 can vary by implementation and can be the same or alternatively can be different numbers of points.

In the discussions herein, the electronic coupon tracking is discussed primarily with reference to electronic coupons being redeemed by a mobile device. It is to be appreciated, however, that alternatively electronic coupons can be redeemed by other devices, such as computing device 108 of FIG. 1. Such other devices redeeming an electronic coupon would include a module analogous to electronic coupon module 146 of FIG. 1.

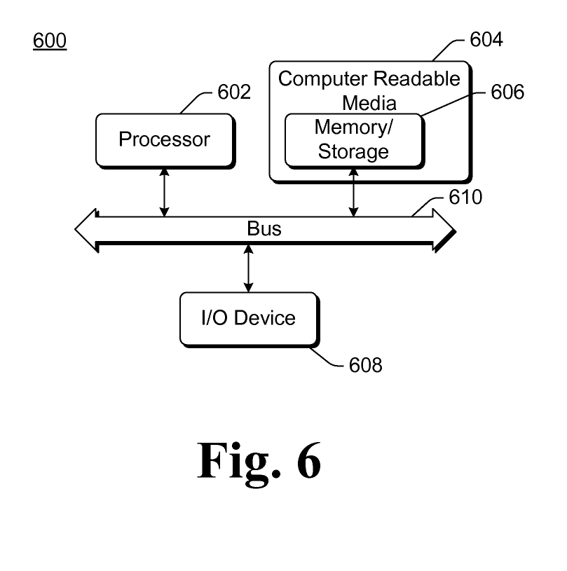

FIG. 6 illustrates an example computing device 600 that can be configured to implement the electronic coupon tracking in accordance with one or more embodiments. Computing device 600 can be, for example, computing device 108 or mobile device 110 of FIG. 1, or can be a device implementing one or more of services 102, 104, and 106 of FIG. 1.

Computing device 600 includes one or more processors or processing units 602, one or more computer readable media 604 which can include one or more memory and/or storage components 606, one or more input/output (I/O) devices 608, and a bus 610 that allows the various components and devices to communicate with one another. Computer readable media 604 and/or one or more I/O devices 608 can be included as part of, or alternatively may be coupled to, computing device 600. Bus 610 represents one or more of several types of bus structures, including a memory bus or memory controller, a peripheral bus, an accelerated graphics port, a processor or local bus, and so forth using a variety of different bus architectures. Bus 610 can include wired and/or wireless buses.

Memory/storage component 606 represents one or more computer storage media. Component 606 can include volatile media (such as random access memory (RAM)) and/or nonvolatile media (such as read only memory (ROM), Flash memory, optical disks, magnetic disks, and so forth). Component 606 can include fixed media (e.g., RAM, ROM, a fixed hard drive, etc.) as well as removable media (e.g., a Flash memory drive, a removable hard drive, an optical disk, and so forth).

The techniques discussed herein can be implemented in software, with instructions being executed by one or more processing units 602. It is to be appreciated that different instructions can be stored in different components of computing device 600, such as in a processing unit 602, in various cache memories of a processing unit 602, in other cache memories of device 600 (not shown), on other computer readable media, and so forth. Additionally, it is to be appreciated that the location where instructions are stored in computing device 600 can change over time.

One or more input/output devices 608 allow a user to enter commands and information to computing device 600, and also allows information to be presented to the user and/or other components or devices. Examples of input devices include a keyboard, a cursor control device (e.g., a mouse), a microphone, a scanner, and so forth. Examples of output devices include a display device (e.g., a monitor or projector), speakers, a printer, a network card, and so forth.

Various techniques may be described herein in the general context of software or program modules. Generally, software includes routines, programs, objects, components, data structures, and so forth that perform particular tasks or implement particular abstract data types. An implementation of these modules and techniques may be stored on or transmitted across some form of computer readable media. Computer readable media can be any available medium or media that can be accessed by a computing device. By way of example, and not limitation, computer readable media may comprise “computer storage media” and “communications media.”

“Computer storage media” include volatile and non-volatile, removable and non-removable media implemented in any method or technology for storage of information such as computer readable instructions, data structures, program modules, or other data. Computer storage media include, but are not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

“Communication media” typically embody computer readable instructions, data structures, program modules, or other data in a modulated data signal, such as carrier wave or other transport mechanism. Communication media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media. Combinations of any of the above are also included within the scope of computer readable media.

Generally, any of the functions or techniques described herein can be implemented using software, firmware, hardware (e.g., fixed logic circuitry), manual processing, or a combination of these implementations. The terms “module,” “functionality,” and “logic” as used herein generally represent software, firmware, hardware, or combinations thereof. In the case of a software implementation, the module, functionality, or logic represents program code that performs specified tasks when executed on a processor (e.g., CPU or CPUs). The program code can be stored in one or more computer readable memory devices, further description of which may be found with reference to FIG. 6. The features of the electronic coupon tracking techniques described herein are platform-independent, meaning that the techniques can be implemented on a variety of commercial computing platforms having a variety of processors.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method comprising:
maintaining a record of an electronic coupon that has been distributed to a user;
receiving an indication that the electronic coupon has been redeemed at a retailer via a mobile device; and
recording that the electronic coupon has been redeemed.

2. A method as recited in claim 1, further comprising:
receiving a request to validate an electronic coupon;
checking whether the electronic coupon has already been redeemed at least a threshold number of times; and
returning an indication that the electronic coupon is valid if the electronic coupon has not been redeemed at least the threshold number of times, and otherwise returning an indication that the electronic coupon is invalid.

3. A method as recited in claim 1, the receiving the indication comprising receiving the indication from the mobile device.

4. A method as recited in claim 1, the receiving the indication comprising receiving the indication from a redemption module of the retailer.

5. A method as recited in claim 1, further comprising crediting, in response to receiving the indication, a rewards account of the user with one or more points.

6. A method as recited in claim 5, further comprising crediting, in response to receiving the indication, a friend's rewards account with one or more points, the friend being another user that identified the electronic coupon for downloading to the mobile device.

7. A method as recited in claim 1, wherein maintaining the record comprises:
receiving a notification that the electronic coupon has been downloaded to the mobile device of the user; and
maintaining a record of an identifier of the electronic coupon and a user identifier of the user.

8. A method as recited in claim 1, the electronic coupon having been identified for downloading to the mobile device by the user searching for the electronic coupon.

9. A method as recited in claim 1, the electronic coupon having been identified for downloading to the mobile device by a friend of the user in a social network of the user.

10. One or more computer storage media having stored thereon multiple instructions that, when executed by one or more processors, cause the one or more processors to:
receive an indication that an electronic coupon has been redeemed by a user; and
credit, in response to receipt of the indication, a rewards account corresponding to the user with one or more points.

11. One or more computer storage media as recited in claim 10, wherein the electronic coupon was redeemed via a mobile device at a retailer.

12. One or more computer storage media as recited in claim 11, wherein the rewards account is part of a retailer-specific loyalty program of the retailer.

13. One or more computer storage media as recited in claim 10, wherein the rewards account is part of a generic loyalty program for multiple retailers.

14. One or more computer storage media as recited in claim 10, wherein to credit the rewards account is to credit the rewards account in addition to giving a discount for an item offered by the electronic coupon to the user.

15. One or more computer storage media as recited in claim 10, wherein the instructions further cause the one or more processors to:
receive a request to redeem points from the rewards account in exchange for a product; and
deduct the points from the rewards account.

16. One or more computer storage media as recited in claim 10, wherein the instructions further cause the one or more processors to:
receive an indication that the electronic coupon has been forwarded to a friend of the user;
receive an indication that the electronic coupon has been redeemed by the friend; and
credit, in response to receipt of the indication that the electronic coupon has been redeemed by the friend, the rewards account with one or more points.

17. One or more computer storage media as recited in claim 10, wherein the instructions further cause the one or more processors to:
receive a notification that the electronic coupon has been downloaded to a mobile device of the user; and
credit, in response to receipt of the notification, the rewards account with one or more points.

18. A method comprising:
receive, from a user, an identification of one or more electronic coupons;
receive, from the user, an identification of a friend in a social network of which the user is a member;
downloading, to a mobile device corresponding to the friend, the one or more electronic coupons;
receive an indication that one of the one or more electronic coupons has been redeemed at a retailer via the mobile device;
credit, in response to the indication that the one electronic coupon has been redeemed, a rewards account corresponding to the user with one or more points; and
credit, in response to the indication that the one electronic coupon has been redeemed, a rewards account corresponding to the friend with one or more points.

19. A method as recited in claim 18, wherein receiving the indication comprises receiving the indication from an electronic coupon module of the mobile device.

20. A method as recited in claim 18, wherein the mobile device comprises a cell phone.
